(19) United States
(12) Patent Application Publication
(10) Pub. No.: US 2022/0309061 A1
(43) Pub. Date: Sep. 29, 2022

(54) MINING MACHINE MANAGEMENT METHOD AND SYSTEM

(71) Applicant: BITROCK PTE. LTD., Singapore (SG)

(72) Inventors: Xuejian Li, Singapore (SG); Haoran Chen, Singapore (SG); Sen Nie, Singapore (SG); Lin Sun, Singapore (SG); Yan Feng, Singapore (SG); Zhifu Wang, Singapore (SG); Fanghui Xu, Singapore (SG); Liang Chen, Singapore (SG)

(21) Appl. No.: 17/411,072

(22) Filed: Aug. 25, 2021

(30) Foreign Application Priority Data
Mar. 25, 2021 (CN) 202110320977.1

(51) Int. Cl. G06F 16/2458; G06F 9/48; H04L 29/08

(52) U.S. Cl. CPC G06F 16/2465; G06F 9/4881; H04L 67/10; G06F 2216/03

(57) ABSTRACT

The embodiments of the present application provide a mining machine management method and system. The method includes: determining the number of target IPs corresponding to the mining machine written in configuration information and an update frequency of data, and starting the corresponding coroutine to collect the data from the mining machine corresponding to the target IPs based on the number of the target IPs and the update frequency of the data; and uploading the data to a local server, and uploading the data to a cloud server by the local server.

### CROSS-REFERENCE TO RELATED APPLICATION

This application is based on and claims the priority benefits of China application No. 202110320977.1 filed on Mar. 25, 2021. The entirety of the above-mentioned patent application is hereby incorporated by reference herein and made a part of this specification.

### TECHNICAL FIELD

The present application relates to the field of blockchain technology, in particular to a mining machine management method and system.

### DESCRIPTION OF RELATED ART

With the rise of digital currency, blockchain technology and digital currency have gradually become well-known. The equipment for mining digital currency has gradually evolved from the initial computer graphics card to a professional mining machine, and has gradually developed from the first few devices to a large-scale mine. In the daily maintenance of the mine, the operating status data of the mining machine needs to be transmitted to a cloud server for analysis and processing, and the maintenance personnel maintain the mining machines in the mine according to the analysis and processing results of the cloud server. However, when the network fails, the operating status data of the mining machine cannot be transmitted to the cloud server in a timely manner, which affects the daily maintenance of the mine.

### SUMMARY

In order to avoid affecting the maintenance work of the mine due to network problems, the present application provides a mining machine management method and system.

In a first aspect, the present application provides a mining machine management method, including: determining the number of target IPs corresponding to a mining machine written in configuration information and an update frequency of data, and starting a corresponding coroutine to collect data from the mining machine corresponding to the target IPs based on the number of the target IPs and the update frequency of the data; and uploading the data to a local server, and further uploading the data by the local server to a cloud server.

Preferably, the step of determining the number of target IPs corresponding to the mining machine written in configuration information and an update frequency of data, and starting the corresponding coroutine to collect data from the mining machine corresponding to the target IPs based on the number of the target and the update frequency of the data includes: determining the number of coroutines to be started according to the number of target IPs; determining a scheduling interval of each coroutine according to the number of coroutines to be started and the update frequency; starting the corresponding number of coroutines; and scheduling the coroutine to collect data from the target IPs according to the scheduling interval.

Preferably, the step of scheduling the coroutine to collect data from the target IPs according to the scheduling interval includes: scheduling one coroutine to collect data from the target IPs; and, after the scheduling interval has elapsed, scheduling the coroutine again to collect data from the target IPs.

Preferably, before uploading the data to a local server, the method further includes: defining a minimum instruction set, and filtering the data collected by each coroutine with the minimum instruction set, in which the minimum instruction set includes a computing power of the mining machine, a speed of a fan in the mining machine, a temperature of the mining machine, a mining pool information, and a chip information.

Preferably, the step of uploading the data to a local server includes: setting the capacity of a pipeline and a time interval for uploading the filtered data; and using the pipeline to upload the filtered data according to the capacity and the time interval.

Preferably, the step of uploading the data via the local server uploading to a cloud server includes: uploading the data to a Kafka cluster by the local server, and grabbing the data from the Kafka cluster by the cloud server.

Preferably, after uploading the data to a cloud server by the local server, the method further includes: establishing a Websocket channel between the local server and the cloud server, and issuing control instructions by the cloud server to the local server through the Websocket channel, in which the control instruction includes a header and data; the header is used to indicate the type of operation to be performed by a control instruction; and the data includes specific operation content of a corresponding operation type, a structure regarding whether to return an operation, and identification information.

Preferably, before determining the number of target IPs corresponding to the mining machine written in configuration information and an update frequency of data, the method further includes: connecting the mining machines in the mine to the same local area network, and when a preset condition is met, issuing the configuration information to the mining machine so that the configuration information is written into the mining machine, in which the configuration information includes URL of the mining pool, a sub-account name and password;

Preferably, the preset condition includes one or more selected from a group consisting of: detecting the inherent parameters of the mining machine for the first time, detecting the parameters bound to the mining machine for the first time, and the IP address of the corresponding mining machine becoming an active IP address for the first time; and the step of issuing the configuration information to the mining machine so that the configuration information is written into the mining machine includes: generating a recognition code for each of the mining machines; and, when the preset condition is met, issuing the configuration information to the mining machine corresponding to the recognition code, so that the configuration information is written into the mining machine.

Preferably, after issuing the configuration information to the mining machine corresponding to the recognition code, the method further includes: recording the MAC address of the mining machine to which the configuration information has been written; creating an identification information corresponding to the MAC address; and binding the identification information to a designated user information to act as a basis for judging the ownership of the mining machine.

In a second aspect, the present application provides a mining machine management system, including: a data collection module, configured for determining the number of target IPs corresponding to the mining machine written in configuration information and an update frequency of data, and starting the corresponding coroutine to collect the data from the mining machine corresponding to the target IPs based on the number of the target IPs and the update frequency of the data; and a data upload module, configured for uploading the data to a local server, and further uploading the data by the local server to a cloud server.

In the mining machine management method and system provided by the embodiments of the present application, the correspondence relationship between the mining machine on a rack in the mine and the IP address in the IP number segment is established. When it is detected that a new active IP appears in the IP number segment, the configuration information is sent to the mining machine corresponding to the new active IP address, so that the configuration information is written into the mining machine, which saves much time needed for configuration and avoids errors caused by manual errors during configuration.

Further, by determining the number of target IPs and the update frequency of data, the number of coroutines to be started is determined according to the number of target IPs, the scheduling interval of each coroutine is determined according to the number of coroutines to be started and the update frequency, a corresponding number of coroutines are started, and the coroutines are scheduled according to the scheduling interval to collect data from the target IP. This can alleviate the network congestion when collecting data.

Further, the data is uploaded to the Kafka cluster through the local server, the cloud server grabs the data from the Kafka cluster and issues control instructions to the local server. In particular, a Websocket channel is established between the local server and the cloud server, and the cloud server issues control instructions to the local server through the Websocket channel. This can alleviate network congestion during data uploading and ensure that the cloud server can independently control the local server.

It should be understood that the content described in the content of the invention is not intended to limit the key or important features of the embodiments of the present application, nor is it intended to limit the scope of the present application. Other features of the present application will be easily understood by the following description.

### BRIEF DESCRIPTION OF THE DRAWINGS

With reference to the accompanying drawings and the following detailed description, the above and other features, advantages, and aspects of the embodiments of the present application will become more apparent. In the drawings, the same or similar reference signs indicate the same or similar elements, in which:

FIG. 1 shows an architecture diagram of a mining machine management system according to an embodiment of the present application;

FIG. 2 shows a flowchart of an automatic mining machine configuration method according to an embodiment of the present application;

FIG. 3 shows a flowchart of a data processing method based on Go language according to an embodiment of the present application;

FIG. 4 shows a flowchart of a data synchronization method between a local server and a cloud server according to an embodiment of the present application;

FIG. 5 shows a block diagram of an automatic mining machine configuration device according to an embodiment of the present application;

FIG. 6 shows a block diagram of a data processing device based on Go language according to an embodiment of the present application;

FIG. 7 shows a block diagram of a data synchronization device of a local server and a cloud server according to an embodiment of the present application; and

FIG. 8 shows a schematic structural diagram of an electronic device suitable for implementing the embodiments of the present application.

### DESCRIPTION OF THE EMBODIMENTS

In order to make the purpose, technical solutions and advantages of the embodiments of the present application clearer, the technical solutions in the embodiments of the present application will be described clearly and completely in conjunction with the accompanying drawings in the embodiments of the present application. Obviously, the described embodiments are parts of the embodiments of the present application, but not all of the embodiments. Based on the embodiments in the present application, all other embodiments obtained by those of ordinary skill in the art without creative work shall fall within the protection scope of the present application.

Term Explanation

A mining pool is a full node that integrates scattered computing power in the blockchain and share rewards among all members by using a method of combining a small amount of computing power to operate jointly.

A mine, also called a mining base, refers to the geographically concentrated distribution form of mining machines.

A mining machine is a computer used to earn bitcoins. This type of computer generally has dedicated mining wafers, which usually work by burning a graphics card, which consumes a lot of power.

A thread is the smallest unit that the operating system can perform an operation scheduling. It is included in a process, acting as the actual operation unit in the process.

A thread pool is a form of multi-threaded processing. During the processing, tasks are added to a queue, and then these tasks are automatically started after threads are created.

A coroutine is essentially a user-mode thread. It does not require the operating system to perform preemptive scheduling and is stored in the thread in the real implementation. Therefore, the system overhead is extremely small and the concurrency of thread tasks can be effectively improved, and the disadvantages of multithreading can be avoided.

A pipeline is a special type in Go language. At any time, only one coroutine can access the pipeline to send and retrieve data. The coroutines can communicate with each other through the pipelines. The pipeline is like a conveyor belt or queue, which always follows a first-in-first-out rule to ensure the order of sending and receiving data.

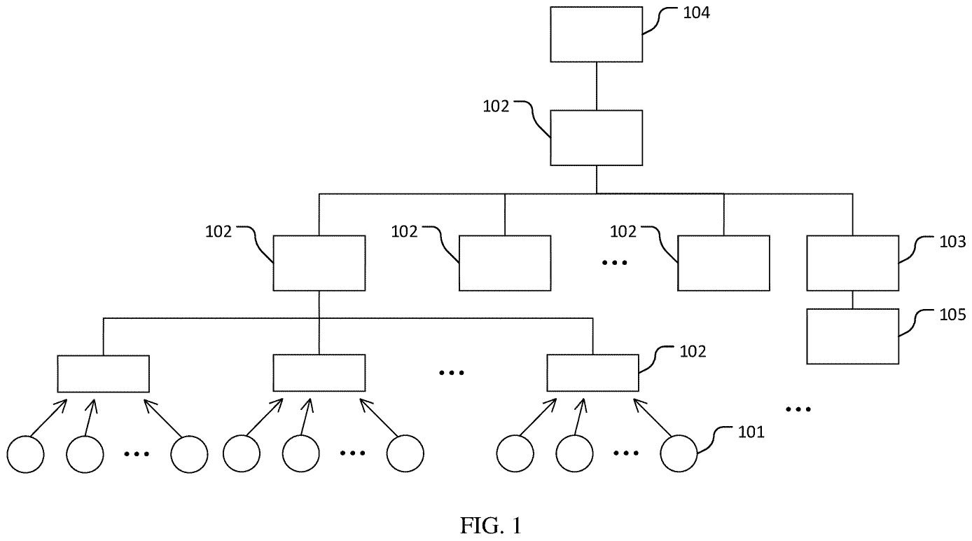

FIG. 1 shows an architecture diagram of a mining machine management system according to an embodiment of the present application.

Referring to FIG. 1, the mining machine management system includes a plurality of mining machines 101, a plurality of switches 102, a local server 103, a cloud server 104, and a client 105.

There is a wired network between the mining machine 101 and the switch 102, between the local server 103 and the switch 102, between the local server 103 and the cloud server 104, and between the local server 103 and the client 105.

In the management system, the plurality of switches 102 can be divided into a first-level switch, a second-level switch, and a third-level switch. Both the second-level switch and the third-level switch may include one or more switches 102. Each of the third-level switches is connected to the plurality of mining machines 101, each of the second-level switches is connected to the plurality of third-level switches, the plurality of second-level switches and the local servers 103 are connected to the first-level switch, and the first-level switch is connected to the cloud server 104.

The local server 103 may include, for example, a processor, a memory, a communication device, and a sniffer. The processor is used to execute program instructions, and the program instructions may use an instruction set of architectures such as Golang, x86, Arm, RISC, MIPS, SSE, etc. The memory includes, for example, ROM (Read Only Memory), RAM (Random Access Memory), nonvolatile memory such as a hard disk, and the like. The communication device can perform wired or wireless communication, for example. The sniffer can collect data from the switch 102, for example.

The cloud server 104 may be a blade server, a rack server, etc., or a server cluster deployed in the cloud, which is not limited here.

In some embodiments, instructions are stored in the processor, and the instructions are used to control the operation of the sniffer to implement or support the implementation of the Go language-based data processing method according to at least some of the embodiments of this specification; and the instructions are also used to control the processor to operate or support the implementation of the automatic mining machine configuration method according to at least some of the embodiments of this specification.

In other embodiments, the processors in the local server 103 and the cloud server 104 both store instructions, which are used to control the local server 103 and the cloud server 104 to operate to implement or support the implementation a data synchronization method of the local server and the cloud server according to at least some of the embodiments of this specification.

Instructions can be designed by those skilled in the art according to the scheme disclosed in this specification. How the instructions control the sniffer, the local server, and the cloud server to operate is common knowledge in the art and will not be described in detail here.

It should be noted that a management system shown in FIG. 1 is only explanatory, and is by no means intended to limit the application or use of the embodiments of the present application. For example, the management system may include a plurality of local servers 103, a plurality of cloud servers 104, and a plurality of clients 105.

In an embodiment of the present application, the mining machine management system further includes at least two mobile terminals, of which at least one mobile terminal is communicatively connected to the client 105, and at least another mobile terminal is communicatively connected to the cloud server 104.

The plurality of switches 102, the local servers 103, and the client 105 are all deployed in the mine. The mining machines 101, the local server 103 and the client 105 in the mine are all connected to the same local area network. It can be seen that the mining machines 101, the local server 103 and the client 105 are not affected by external network signals, and can work normally as long as it is ensured that there is no power failure in the mine.

The sniffer is configured in the local server 103, and the sniffer is used to collect operating parameters of the mining machine 101.

In an example, the operating parameters of the mining machine may include, for example, the number information, location information, CPU temperature information, computing power information, the number of computing power boards, and a fan speed of each mining machine.

The local server 103 may be a blade server, a rack server, or the like. The local server 103 is used to analyze and process the operating parameters to generate display information and/or alarm information, and transmit the display information and/or alarm information to the client 105 via the local area network.

In an example, the display information may include, for example, the number information and the location information of all the mining machines in the mine, as well as the CPU temperature information, computing power information, the number of computing power boards, the fan speed, etc. of the corresponding mining machine. The alarm information may include, for example, a computing power board failure, abnormal CPU temperature, no computing power, and so on.

The client 105 may be a desktop computer, for example. The client 105 is used to display the display information and/or alarm information.

The local server 103 and the cloud server 104 communicate through a wired network. When the communication between the local server 103 and the cloud server 104 is normal, when the local server 103 transmits the display information and/or alarm information to the client 105 via the local area network, it also synchronizes the display information and/or alarm information through the wired network to the cloud server 104.

The cloud server 104 may be a server cluster deployed in the cloud. The cloud server 104 is configured to store display information and/or alarm information, and deliver the display information and/or alarm information to at least one mobile terminal through a wireless network.

The mobile terminal may be, for example, a wearable device such as a mobile phone, a tablet computer, or a bracelet, which is not specifically limited in the embodiment of the present application. The operating system in the mobile terminal is an Android operating system.

It should be noted that the mobile terminal connected to the client 105 can be used by maintenance personnel in the mine, and the mobile terminal connected to the cloud server 104 can be used by the owner of the mine. The specific number can be selected according to needs, and is not limited here. Of course, the mobile terminal 110 connected to the client 105 can also be used by the mine owner, and the mobile terminal connected to the cloud server 104 can also be used by maintenance personnel in the mine.

For example, when the maintenance personnel in the mine perform routine maintenance on the mining machine, they can receive the display information and/or alarm information issued by the cloud server 104 through the mobile terminal. Since the display information and/or alarm information contains the location information and the number information of the mining machine, when a certain mining machine is abnormal, the maintenance personnel can quickly and accurately find the mining machine through the mobile terminal and maintain it.

For another example, when a mine owner needs to check the operating status of the mining machines in the mine, he can receive the display information and/or alarm information sent by the cloud server 104 through a mobile terminal, so that he can clearly know the operating status of all mining machines.

In some embodiments, a barcode (for example, a one-dimensional barcode or a two-dimensional code) is provided on or near the mining machine in the mine, and the barcode is used to characterize the distribution position information of the mining machine in the mine. Both the local server 103 and the cloud server 104 are equipped with a distribution topology map of the mining machines in the mine. Each of the mining machines in the distribution topology map corresponds to a mining machine at the corresponding position in the mine, that is, there is a corresponding relationship between the actual position of the mining machines and the position in the distribution topology map.

For example, in the daily maintenance process, the maintenance personnel can use the mobile terminal to scan the barcode to find out the location information of the mining machine corresponding to the barcode, and send the location information to the cloud server 104, and the cloud server 104 finds out the corresponding mining machine and its operating parameters based on the location information, and deliver the operating parameters to the mobile terminal for maintenance personnel to view.

Of course, the way to obtain the operating parameters can also be that the cloud server 104 transmits the above-mentioned location information to the local server 103, and the local server 103 finds the corresponding mining machine and its operating parameters according to the location information, and transmits the operating parameters to the cloud server 104, the cloud server 104 delivers to the mobile terminal for maintenance personnel to view.

In some embodiments, in order to prevent the communication failure between the local server 103 and the cloud server 104 from affecting the normal operation of the system, the system may include a wireless network module, which may be provided in the switch. When the communication between the local server 103 and the cloud servers 104 fails, the local server 103 issues the display information and/or alarm information to the mobile terminal through the wireless network module, so that the maintenance personnel in the mine can receive the information in time to deal with the failure.

In some embodiments, when the communication between the local server 103 and the cloud server 104 fails, when the mobile terminal scans the barcode, the location information represented by the barcode can be sent to the local server 103 through the wireless network module, so as to obtain the operating status information of the mining machine corresponding to the barcode from the local server 103.

According to the embodiment of the present application, a client and a local server are deployed in the mine and connected through a local area network. The local server analyzes and processes the operating parameters of the mining machine collected by the sniffer and generates display information and/or alarm information. The client server is used to display the display information and/or alarm information, and the local server can also synchronize the display information and/or alarm information to the cloud server. When the network fails, that is, the communication between the local server and the cloud server is disconnected, the normal operation of the collection device, the client server and the local server will not be affected, so as to avoid affecting the maintenance work of the mine due to network problems.

Each part of the mining machine management system will be described in detail below in conjunction with specific embodiments.

When the mining machine is used for the first time, it needs to configure a mining pool information to change the attribution of the income generated by its mining. The following first introduces how to configure the mining pool information in the mining machine.

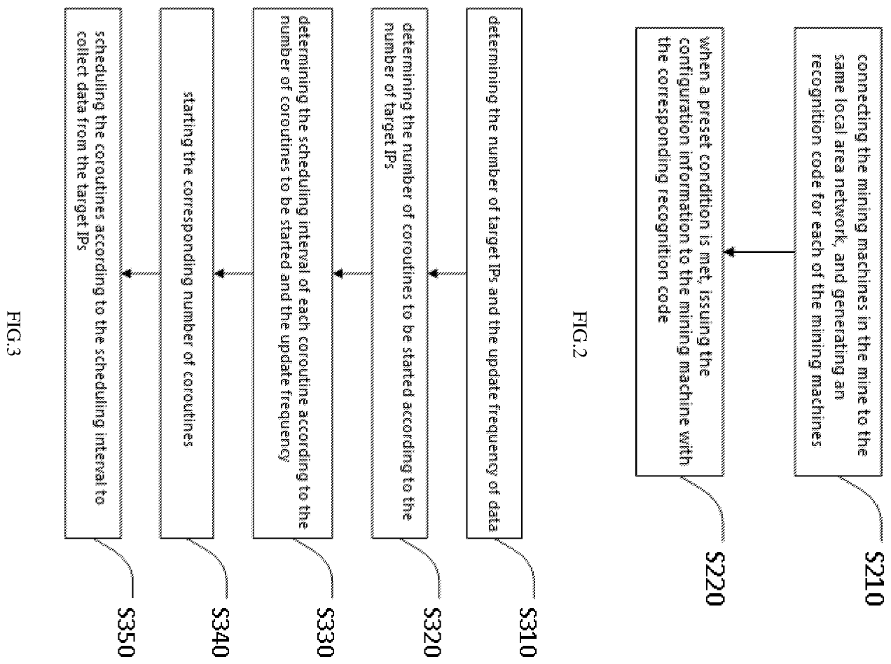

FIG. 2 shows a flowchart of an automatic mining machine configuration method according to an embodiment of the present application. In some embodiments, the automatic mining machine configuration method may be executed by the client 105 in FIG. 1.

Referring to FIG. 2, the automatic mining machine configuration method includes the following steps:

Step 210, connecting the mining machines in the mine to the same local area network, and generating a recognition code for each mining machine.

Step 220, when a preset condition is met, issuing the configuration information to the mining machine with the corresponding recognition code, so that the configuration information is written into the mining machine.

Here, the preset condition includes one or more selected from a group consisting of: detecting inherent parameters of the mining machine for the first time, detecting parameters bound to the mining machine for the first time, and the IP address of the corresponding mining machine becoming an active IP address for the first time.

In this embodiment, the inherent parameters of the mining machine include, but not limited to, the speed of the fan in the mining machine, the temperature of the mining machine, and chip information. The parameters bound to the mining machine include, but not limited to, the mining pool URL, a sub-account name and password bound to the mining machine. When the inherent parameters of the mining machine are detected for the first time or the parameters bound to the mining machine are detected for the first time, it means that the mining machine is powered on for the first time in the mine. At this time, the configuration information needs to be issued to the mining machine so that the configuration information is written into the mining machine to change the attribution of the income generated by its mining.

In this embodiment, a plurality of racks can be placed in the mine, and a plurality of mining machines can be placed on the racks. Then, each rack can be allocated with a separate IP number segment to establish the corresponding relationship between the IP address in the IP number segment and the mining machine on the rack; or a plurality of racks can share an IP number segment to establish the correspondence between the IP address in the IP number segment and the mining machines on the plurality of racks.

For example, the allocation of IP number segments can be determined according to the number of IP addresses in the IP number segment and the number of mining machines on the rack. The IP number segment 192.168.100.1-192.168.100.254 contains 254 IP addresses, and there are 80 mining machines on each rack, then the IP number 192.168.100.1-192.168.100.254 can be allocated to 3 racks, and each mining machine on each rack corresponds to one IP address in the IP number segment.

For another example, a distribution topological map of the racks in the mine and the mining machines placed on the racks may be drawn, assigning one IP number segment to each rack, and assigning one IP address to each mining machine in the rack, and the IP address belonging to the IP number segment to establish the correspondence relationship between the mining machine and the IP address.

When a new active IP address appears in the IP number segment, that is, when the mining machine corresponding to the IP address is powered on for the first time and/or connects to the network for the first time, the corresponding IP address is the new active IP address. At this time, the configuration information needs to be delivered to the mining machine, so that the configuration information is written into the mining machine to change the attribution of the income generated by its mining.

In this embodiment, the configuration information includes a mining pool URL, a sub-account name and a password. The mining pool URL is used to connect the mining pool, obtain and submit tasks to complete the PoW workload; the sub-account name as the name of the sub-account created in the mining pool is used as an indicator of the amount of work contributed by the PoW in the mining pool by absenteeism; and the password, generally not used as a password, can be used to set the lower limit of the difficulty for the mining machine to accept tasks in the mining pool.

In some embodiments, one mining pool URL, one sub-account name, and one password constitute a complete set of mining pool configurations, and the configuration information may include three sets of mining pool configurations. Among them, the first set of mining pool configuration is used as a main mining pool configuration, and the other two sets of mining pool configurations are used as backup mining pool configurations. When the first set of mining pool configurations cannot be connected to obtain mining pool tasks, the last two mine pools will be tried for collection at one time, so as to ensure the stability of the mining machine.

In some embodiments, after issuing the configuration information to the mining machine with the corresponding recognition code, the method further includes the following steps: first, recording the MAC address of the mining machine to which the configuration information has been written; then, creating an identification information corresponding to the MAC address; and finally, binding the identification information to a designated user information.

In this embodiment, the MAC address of the mining machine is recorded, and identification information corresponding to the MAC address is created, and the identification information is bound to the designated user, so as to provide a basis for determining the ownership of the mining machine.

According to the embodiment of the present application, by connecting the mining machines in the mine to the same local area network and generating an recognition code for each mining machine, when detecting the inherent parameters of the mining machine for the first time, or binding the parameters to the mining machine are detected for the first time, or the IP address of a corresponding mining machine becoming the active IP address for the first time, the configuration information can be issued to the mining machine with the corresponding recognition code, so that the configuration information is written into the mining machine. This can save much time needed for configuration compared to manual configuration, and at the same time avoids errors caused by manual errors during configuration.

After the configuration of the mining machine is completed, the mining machine can be put into normal mining work, but during the mining process of the mining machine, the parameters of the mining machine need to be collected in real time to monitor the mining machine.

In some application scenarios, for example, it is necessary to collect data from 7000 Shenma mining machines, and collect data every minute.

When using the thread pool to collect the data of the above mining machines, each Shenma mining machine has two ports, being 80 port and 4028 port. During one data collection process, 80 port needs to be accessed 3 times, and 4028 port needs to be accessed one time. It takes an average of 10 s for the thread to access the port once and return, that is to say, it takes 40 s to collect data on the Shenma mining machine once.

However, when the thread returns, due to the intensive I/O, there will be a lot of waiting when the thread returns, resulting in delayed return, causing network congestion, and thus making it impossible to collect once per minute.

To this end, the embodiments of the present application provide a data processing method, device, electronic device, and storage medium based on Go language, which can improve network congestion when collecting data.

FIG. 3 shows a flowchart of a data processing method based on Go language according to an embodiment of the present application. In some embodiments, the data processing method based on the Go language may be executed by the local server 103 in FIG. 1.

Referring to FIG. 3, the method includes the following steps:

Step 310, determining the number of target IPs and the update frequency of data.

For example, the number of target IPs may be determined according to the number of mining machines in the mine. When collecting data of the mining machines, each mining machine needs to be configured with an IP address, that is, the number of target IPs may be the same as the number of mining machines. For example, if there are 10,000 mining machines in a mine, and data collection needs to be performed on the 10,000 mining machines, it can be determined that the number of target IPs required is 10,000.

The update frequency of the data can be, for example, updated once every 60 seconds, once every 30 seconds, or once at other intervals. The specific data can be set by those skilled in the art according to actual needs, which will not be limited here.

Step 320, determining the number of coroutines to be started according to the number of target IPs.

Each coroutine is only responsible for collecting data from one target IP and returning it, so the number of coroutines to be started may be the same as the number of target IPs.

Step 330, determining the scheduling interval of each coroutine according to the number of coroutines to be started and the update frequency.

The scheduling interval is a time interval between the last coroutine being scheduled to perform the data collection operation and the next coroutine being scheduled to perform the data collection operation.

The scheduling interval may be calculated by the following formula, for example:

$$scheduling interval = \frac{number of coroutines to be started}{update frequency}$$

For example, if it needs to collect data on 10,000 mining machines, and the update frequency is 60 seconds, then the number of coroutines to be started is 10,000, and the scheduling interval of each coroutine is calculated as 6 milliseconds by the above formula, that is to say, a coroutine is scheduled every 6 milliseconds to collect the data of the mining machine from the corresponding target IP.

Step 340, starting the corresponding number of coroutines.

The corresponding number is the number of coroutines to be started determined in step 202.

Step 350, scheduling the coroutines according to the scheduling interval to collect data from the target IP.

In some embodiments, the step of scheduling the coroutine according to the scheduling interval to collect data from the target IP may adopt the following steps:

scheduling one coroutine to collect the data from the target IP; and

after the scheduling interval has elapsed, scheduling the coroutine again to collect data from the target IP.

In some embodiments, after scheduling the coroutine according to the scheduling interval to collect data from the target IP, the data needs to be uploaded. The specific steps for uploading are as follows:

Step 360, defining a minimum instruction set, and filtering the data collected by each coroutine with the minimum instruction set.

In this embodiment, the minimum instruction set includes a computing power of the mining machine, a speed of a fan in the mining machine, a temperature of the mining machine, a mining pool information, and a chip information. the minimum instruction set includes a computing power of the mining machine, a speed of a fan in the mining machine, a temperature of the mining machine, a mining pool information, and a chip information.

For example, the minimum instruction set may be expressed as follows:

```
{
“hashrate”: 56797963170000,
“temperature”: 72,
pods: [
  “addr”: “stratum+tcp://atlas-vip.okpool.top:3333”,
  “user”: “Atlas02CHB.6x80x16”
],
  chips: [
    {
      “asic”: 66,
      “hashrate”: 20833743530000
}
}
```

It should be noted that due to the many types of mining machines, when collecting data that can represent the performance of the mining machine, the data needs to be filtered in the form of the minimum instruction set, and the rest of the data is filtered out to prevent the local server's disk from generating a large of fragments under a long time running.

However, due to the fact that, after filtering, different brands of mining machines may use different units for expressing the same parameter, it is required to unify the units after filtering, so as to facilitate compatibility between mining machines of different brands or models

Step 370, uploading the filtered data.

In some embodiments, uploading the filtered data may adopt the following steps,

Step 3701, setting the capacity of a pipeline and a time interval for uploading the filtered data.

Since the pipeline always follows a rule of First-In-First-Out to guarantee the order of sending and receiving data, the data can be queued in the pipeline by setting the capacity of the pipeline, so that the data in the pipeline follows the rule of First-In-First-Out. By setting the time interval for uploading the filtered data, the filtered data can be uploaded one by one according to the time interval.

Step 3702, using the pipeline to upload the filtered data according to the capacity and the time interval.

In this embodiment, uploading data in a pipeline manner makes it possible to avoid large peaks and valleys during data upload, while ensuring smooth data upload.

According to the embodiment of the present application, by determining the number of target IPs and the update frequency of data, determining the number of coroutines to be started according to the number of target IPs, and determining the scheduling interval of each coroutine according to the number of coroutines to be started and the update frequency, the corresponding number of coroutines are started and coroutines are scheduled according to the scheduling interval to collect data from the target IP. All the coroutines are executed at the same priority since there is no priority between each coroutine. Further, during the data collection, for the same target IP, only one coroutine performs collection and return operations. Therefore, there will be no network congestion, which can alleviate the network congestion when collecting data.

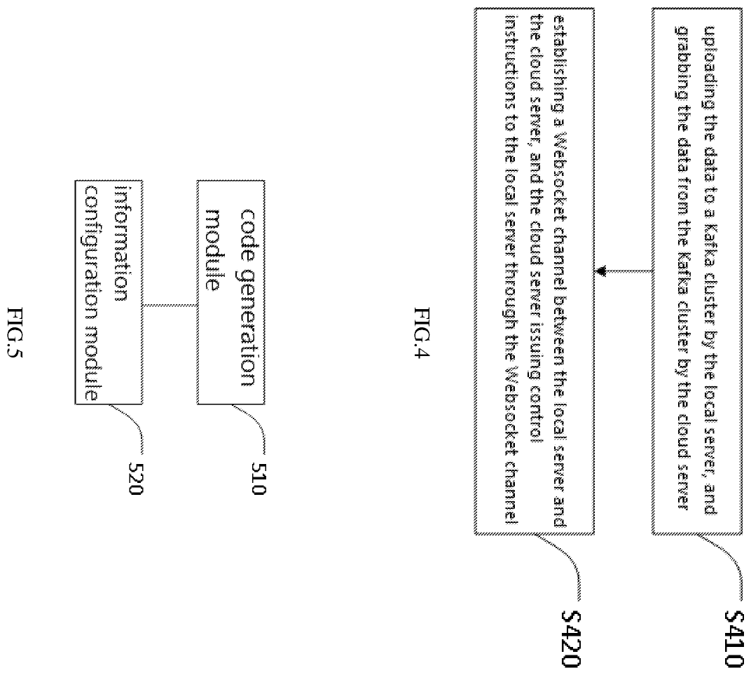

After the local server 103 collects the operating data of the mining machine, it needs to synchronize the data with the cloud server 104. The specific synchronization method can be seen in FIG. 4, which shows a flowchart of a data synchronization method of the local server and the cloud server according to an embodiment of the present application.

As shown in FIG. 4, the method includes the following steps:

Step 410, the local server uploading the data to a cloud server, including uploading the data to a Kafka cluster by the local server, and grabbing the data from the Kafka cluster by the cloud server.

In this embodiment, when the local server uploads data to the Kafka cluster, it can be uploaded according to a timed task.

In some embodiments, when the local server uploads data to the Kafka cluster, the data may be cleaned, sorted, and processed first, and the processed data is uploaded to the Kafka cluster.

For example, the data can be filtered according to preset conditions. The preset conditions include, but not limited to, the abnormal 4028 port of the mining machine, abnormal MAC address of the mining machine, etc. For data filtering, filtering conditions can also be set based on specific business types.

For example, when sorting data, the data can be structured and classified.

For example, when processing data, the data can be formed into a form of a report.

Step 420, the cloud server issuing control instructions to the local server, including establishing a Websocket channel between the local server and the cloud server, and the cloud server issuing control instructions to the local server through the Websocket channel.

In this embodiment, the control instruction includes a header and data, the header is used to indicate the type of operation that a control instruction needs to perform, and the data includes the specific operation content of the corresponding operation type, a structure regarding whether to return an operation, and identification information.

It should be noted that for the foregoing method embodiments, for the sake of simple description, they are all expressed as a series of action combinations. However, those skilled in the art should know that the present application is not limited by the described sequence of actions, since some steps can be performed in other order or at the same time according to the present application. Secondly, those skilled in the art should also know that the embodiments described in the specification are all optional embodiments, and the involved actions and modules are not necessarily required by the present application.

The above is an introduction to the method embodiments. Technical solutions of the present application will be further explained by the following device embodiments.

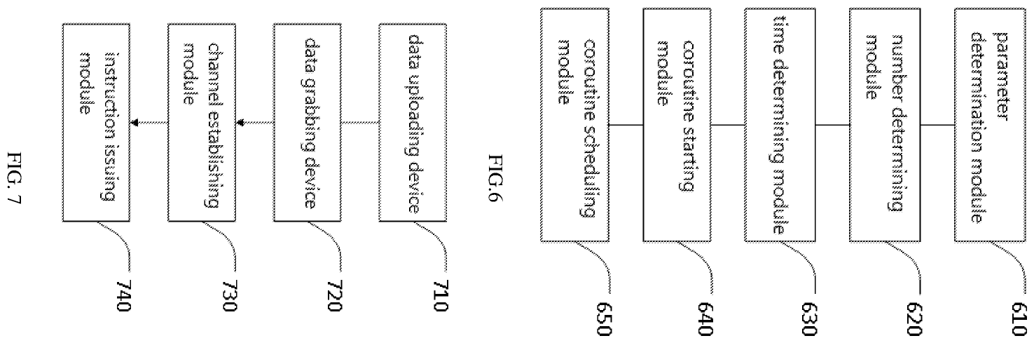

FIG. 5 shows a block diagram of an automatic mining machine configuration device according to an embodiment of the present application. In some embodiments, the apparatus may be included in the client 105 of FIG. 1 or implemented as the client 105.

As shown in FIG. 5, the automatic mining machine configuration device includes:

a code generation module 510, configured for connecting the mining machines in the mine to the same local area network, and generating a recognition code for each mining machine;

an information configuration module 404, configured for issuing the configuration information to the mining machine with the corresponding recognition code so that the configuration information is written into the mining machine when a preset condition is met.

Here, the preset condition includes one or more selected from a group consisting of: detecting the inherent parameters of the mining machine for the first time, detecting the parameters bound to the mining machine for the first time, and the IP address of the corresponding mining machine becoming an active IP address for the first time.

In some embodiments, the device further includes:

an information recording module, configured for recording the MAC address of the mining machine to which the configuration information has been written;

an information creating module, configured for creating identification information corresponding to the MAC address; and

an information binding module, configured for binding the identification information with the designated user information to acting as a basis for judging the ownership of the mining machine.

In some embodiments, the configuration information includes the mining pool URL, a sub-account name and password.

FIG. 6 shows a block diagram of a data processing device based on Go language according to an embodiment of the present application. In some embodiments, the device may be included in the local server 103 of FIG. 1 or implemented as the local server 103.

As shown in FIG. 6, the device includes:

a parameter determination module 610, configured for determining the number of target IPs and the update frequency of data, in which one target IP corresponds to a mining machine in the mine;

a number determining module 620, configured for determining the number of coroutines to be started according to the number of target IPs;

a time determining module 630, configured for determining the scheduling interval of each coroutine according to the number of coroutines to be started and the update frequency;

a coroutine starting module 640, configured for starting the corresponding number of coroutines; and

a coroutine scheduling module 650, configured for scheduling the coroutines according to the scheduling interval to collect data from the target IPs.

In some embodiments, the coroutine scheduling module 650 is specifically for scheduling one coroutine to collect data from the target IP; and after the scheduling interval has elapsed, scheduling the coroutine again to collect data from the target IP.

In some embodiments, the device further includes:

a data filtering module 660, configured for defining a minimum instruction set, and filtering the data collected by each coroutine with the minimum instruction set, in which the minimum instruction set includes a computing power of the mining machine, a speed of a fan in the mining machine, a temperature of the mining machine, a mining pool information, and a chip information; and

a data upload module 670, configured for uploading the filtered data.

In some embodiments, a data upload module 670 is specifically configured for setting the capacity of a pipeline and a time interval for uploading the filtered data; and uploading the filtered data via a pipeline according to the capacity and the time interval.

FIG. 7 shows a block diagram of a data synchronization device of a local server and a cloud server according to an embodiment of the present application.

As shown in FIG. 7, the device includes:

a data uploading device 710 configured for enabling the local server to upload data to the Kafka cluster;

a data grabbing device 720 configured for enabling the cloud server to grab data from the Kafka cluster;

a channel establishing module 730 configured for establishing a Websocket channel between the local server and the cloud server; and

an instruction issuing module 740 configured for enabling the cloud server to issue control instructions to the local server through the Websocket channel.

In some embodiments, the data uploading device 710 is specifically configured for enabling the local server to upload data to the Kafka cluster according to a timed task.

In some embodiments, the data uploading device 710 is further specifically configured for enabling the local server to clean, sort and process data; and uploading the processed data to the Kafka cluster according to a timed task.

In some embodiments, the control instruction includes a frame header and data information; the frame header is used to indicate the type of operation that a control instruction needs to perform; and the data information includes the specific operation content of the corresponding operation type, In some embodiments, the control instruction includes a frame header and data information; the frame header is used to indicate the type of operation that a control instruction needs to perform; and the data information includes the specific operation content of the corresponding operation type, a structure regarding whether to return an operation, and identification information.

Those skilled in the art can clearly understand that, for the convenience and conciseness of the description, the specific working process of the described module can refer to the corresponding process in the foregoing method embodiment, which will not be repeated here.

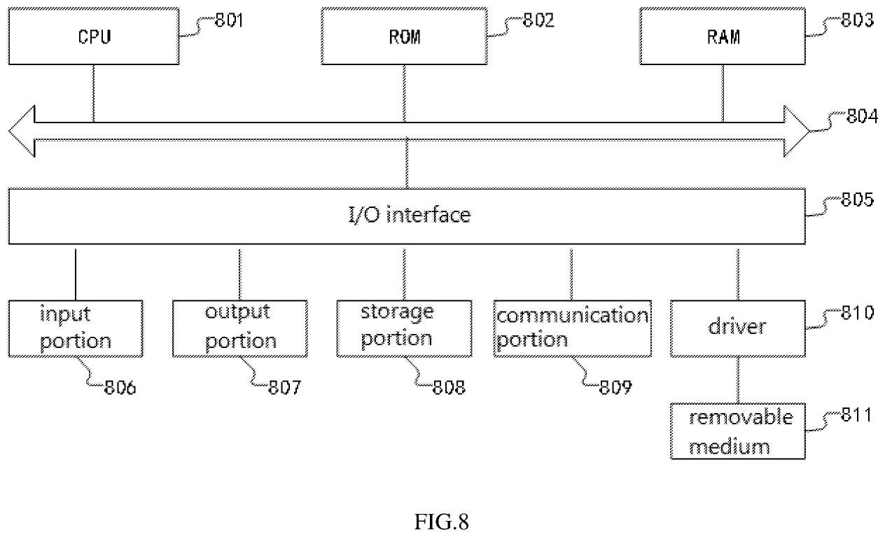

FIG. 8 shows a schematic structural diagram of an electronic device suitable for implementing the embodiments of the present application.

As shown in FIG. 8, the electronic device includes a central processing unit (CPU) 801, which can perform various appropriate actions and processing based on a program stored in a read-only memory (ROM) 802 or a program loaded from a storage portion 808 into a random access memory (RAM) 803. In the RAM 803, various programs and data required for system operation are also stored. The CPU 801, the ROM 802, and the RAM 803 are connected to each other through a bus 804. An input/output (I/O) interface 805 is also connected to the bus 804.

The following components are connected to the I/O interface 805: an input portion 806 including a keyboard, a mouse, etc.; an output portion 807 including a cathode ray tube (CRT), a liquid crystal display (LCD), etc., and speakers, etc.; a storage portion 808 including a hard disk, etc.; and a communication portion 809 including a network interface card such as a LAN card, a modem, and the like. The communication portion 809 performs communication processing via network such as the Internet. The driver 810 is also connected to the I/O interface 805 as needed. The removable medium 811, such as a magnetic disk, an optical disk, a magneto-optical disk, a semiconductor memory, etc., is installed on the driver 810 as needed, so that the computer program read from it is installed into the storage portion 808 as needed.

In particular, according to the embodiments of the present application, the processes described above with reference to the flowcharts of FIG. 2, FIG. 3, and FIG. 4 can be implemented as a computer software program. For example, the embodiments of the present application include a computer program product, which includes a computer program carried on a machine-readable medium, and the computer program includes program code for executing the method shown in the flowchart. In such an embodiment, the computer program may be downloaded and installed from the network through the communication portion 809, and/or installed from the removable medium 811. When the computer program is executed by the central processing unit (CPU) 801, the above-mentioned functions defined in the system of the present application are executed.

It should be noted that the computer-readable medium shown in the present application may be a computer-readable signal medium or a computer-readable storage medium, or any combination of the above two. The computer-readable storage medium may be, for example, but not limited to, an electrical, magnetic, optical, electromagnetic, infrared, or semiconductor system, device, or means, or a combination of any of the above. More specific examples of computer-readable storage media may include, but not limited to, electrical connections with one or more wires, portable computer disks, hard disks, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above. In the present application, the computer-readable storage medium may be any tangible medium that contains or stores a program, and the program may be used by or in combination with an instruction execution system, apparatus, or device. In the present application, a computer-readable signal medium may include a data signal propagated in a baseband or as a part of a carrier wave, and a computer-readable program code is carried therein. This propagated data signal can take many forms, including but not limited to electromagnetic signals, optical signals, or any suitable combination of the foregoing. The computer-readable signal medium may also be any computer-readable medium other than the computer-readable storage medium. The computer-readable medium may send, propagate, or transmit the program for use by or in combination with the instruction execution system, apparatus, or device. The program code contained on the computer-readable medium can be transmitted by any suitable medium, including but not limited to: wireless, wire, optical cable, RF, etc., or any suitable combination of the above.

The flowcharts and block diagrams in the accompanying drawings illustrate the possible implementation of the system architecture, functions, and operations of the system, method, and computer program product according to various embodiments of the present application. In this regard, each block in the flowchart or block diagram may represent a module, program segment, or part of the code, and the aforementioned module, program segment, or part of the code contains one or more executable instructions for realizing the specified logical function. It should also be noted that, in some alternative implementations, the functions marked in the block may also occur in a different order from the order marked in the drawings. For example, two blocks shown in succession can actually be executed substantially in parallel, and they can sometimes be executed in the reverse order, depending on the functions involved. It should also be noted that each block in the block diagram and/or flowchart and the combination of the blocks in the block diagram and/or flowchart can be implemented by a dedicated hardware-based system that performs the specified functions or operations, or can be realized by a combination of dedicated hardware and computer instructions.

The units or modules involved in the embodiments described in the present application can be implemented in software or hardware. The described unit or module may also be provided in a processor, for example, it may be described as: a processor includes a code generation module and an information configuration module. Here, the names of these units or modules do not constitute a limitation on the units or modules themselves under certain circumstances. For example, the code generation module can also be described as a module for connecting the mining machines in the mine to the same local area network, and generating a recognition code for each mining machine.

As another aspect, the present application also provides a computer-readable storage medium. The computer-readable storage medium may be included in the electronic device described in the above embodiments; or it may exist alone without being assembled into the electronic device. The above-mentioned computer-readable storage medium stores one or more programs, wherein the above-mentioned programs are used by one or more processors to execute the automatic mining machine configuration method, the data processing method based on Go language, and the data synchronization method of the local server and the cloud server.

The above descriptions are only preferred embodiments of the present application and explanations of the applied technical principles. Those skilled in the art should understand that the scope of the application involved in the present application is not limited to the technical solutions formed by the specific combination of the above technical features, and should also cover other technical solutions formed by arbitrarily combining the above technical features or equivalent features without departing from the concept of the aforementioned application, For example, technical solutions formed by replacing the above-mentioned features with (but not limited to) technical features having similar functions applied in the present application.

What is claimed is:

1. A mining machine management method, comprising:
determining the number of target IPs corresponding to a mining machine written in configuration information and an update frequency of data, and starting a corresponding coroutine to collect data from the mining machine corresponding to the target IPs based on the number of the target IPs and the update frequency of the data; and
uploading the data to a local server, and uploading the data by the local server to a cloud server.

2. The method according to claim 1, wherein the step of determining the number of target IPs corresponding to a mining machine written in configuration information and an update frequency of data, and starting a corresponding coroutine to collect the data from the mining machine corresponding to the target IPs based on the number of the target IPs and the update frequency of the data comprises:
determining the number of coroutines to be started according to the number of target IPs;
determining a scheduling interval of each coroutine according to the number of coroutines to be started and the update frequency;
starting the corresponding number of coroutines; and
scheduling the coroutine to collect the data from the target IPs according to the scheduling interval.

3. The method according to claim 2, wherein the step of scheduling the coroutine to collect the data from the target IPs according to the scheduling interval comprises:
scheduling one coroutine to collect data from the target IPs; and
after the scheduling interval has elapsed, scheduling the coroutine again to collect data from the target IPs.

4. The method according to claim 2, before said uploading the data to a local server, further comprising:
defining a minimum instruction set, and filtering the data collected by each coroutine with the minimum instruction set, wherein the minimum instruction set comprises a computing power of the mining machine, a speed of a fan in the mining machine, a temperature of the mining machine, a mining pool information, and a chip information.

5. The method according to claim 4, wherein the step of uploading the data to a local server comprises:
setting the capacity of a pipeline and a time interval for uploading the filtered data; and
using the pipeline to upload the filtered data according to the capacity and the time interval.

6. The method according to claim 1, wherein the step of uploading the data to a cloud server by the local server comprises:
uploading the data to a Kafka cluster by the local server, and grabbing the data from the Kafka cluster by the cloud server.

7. The method according to claim 1, after uploading the data to a cloud server by the local server, further comprising:
establishing a Websocket channel between the local server and the cloud server, and issuing control instructions by the cloud server to the local server through the Websocket channel;
wherein the control instruction comprises a header and data;
the header is used to indicate the type of operation to be performed by a control instruction; and
the data comprises the specific operation content of a corresponding operation type, a structure regarding whether to return an operation, and identification information.

8. The method according to claim 1, before determining the number of target IPs corresponding to a mining machine written in configuration information and an update frequency of data, further comprising:
connecting the mining machines in the mine to the same local area network, and when a preset condition is met, issuing the configuration information to the mining machine so that the configuration information is written into the mining machine, wherein the configuration information comprises the URL of the mining pool, a sub-account name and password.

9. The method according to claim 8, wherein the preset condition comprises one or more selected from a group consisting of: detecting inherent parameters of the mining machine for the first time, detecting parameters bound to the mining machine for the first time, and the IP address of the corresponding mining machine becoming an active IP address for the first time; and
the step of issuing the configuration information to the mining machine so that the configuration information is written into the mining machine comprises:
generating recognition codes for each of the mining machines;
when the preset condition is met, issuing the configuration information to the mining machine corresponding to the recognition code, so that the configuration information is written into the mining machine;
recording the MAC address of the mining machine to which the configuration information has been written;
creating identification information corresponding to the MAC address; and
binding the identification information to a designated user information to act as a basis for judging the ownership of the mining machine.

10. A mining machine management system, comprising:
a mining machine configuration module, configured for connecting mining machines in the mine to the same local area network, and when a preset condition is met, issuing the configuration information to the mining machine so that the configuration information is written into the mining machines;
a data collection module, configured for determining the number of target IPs corresponding to a mining machine written in configuration information and an update frequency of data, and starting the corresponding coroutine to collect data from the mining machine corresponding to the target IPs based on the number of the target and the update frequency of the data;
a data upload module, configured for uploading the data to a local server, and uploading the data to a cloud server by the local server.
